(19) United States
(12) Patent Application Publication
(10) Pub. No.: US 2024/0289896 A1
(43) Pub. Date: Aug. 29, 2024

(54) SYSTEM AND METHOD FOR DYNAMICALLY FACILITATING SOCIAL PLATFORM INTERACTION

(71) Applicant: VENCHUR AVE INC., Lafayette, LA (US)

(72) Inventor: Timothy Allen Washington, Lafayette, LA (US)

(73) Assignee: VENCHUR AVE INC., Lafayette, LA (US)

(21) Appl. No.: 18/173,770

(22) Filed: Feb. 23, 2023

(51) Int. Cl. G06Q 50/00; H04L 51/52

(52) U.S. Cl. CPC G06Q 50/01; H04L 51/52

(57) ABSTRACT

A system and method for a social networking platform is described herein. The method includes the selection of a mood by a first user, and providing the first user with compatible users based on the mood. The provided compatible users may be chosen based on their respective mood. The first user may send an offer to one of the compatible users, and that compatible user may then accept, decline, or decline that offer. The offer may be a question such as whether a user would like to meet somewhere, whether a user would like to chat, or whether a user would like to play a game.

### BACKGROUND

The Internet has been helping people connect with each other for decades now. As the Internet has matured, smartphone apps have become popular, and allowed users to meet each other.

As various social networks flooded the market, many left something lacking. For example, apps may have provided a user with other user profiles based on their location, and then immediately allowed the users to chat. Unfortunately, this method often results in connecting users that do not have the same objectives.

As a result, there is a need in the art for a social network that better connects people based on specific factors.

### SUMMARY

A need exists for a social network that connects people based on certain characteristics such as their mood.

In general, in one aspect, embodiments relate to a method for receiving a mood indication from a first client computing device. At least two sets of grouping criteria may be applied to a set of accounts to generate an eligible group. An eligible group may be a subset of the set of accounts, and created by applying the at least two sets of grouping criteria which may include only accounts with an associated mood qualifying as compatible with the mood indication and only accounts associated with client computing devices within a geographic distance of the first client computing device. The first client computing device may be provided with an eligible group for display, and an identification of a selected account from the eligible group and an offer may be received from the first client computing device. A second client computing device associated with a second user account may be provided with the offer, and the second client computing device may provide a response to the offer. After the response is sent, a notification indicating the first response may be provided to the client computing device that sent the offer.

In another aspect, embodiments relate to a system that receives a mood indication from a first client computing device. The system may apply at least two sets of grouping criteria to a set of accounts of a social networking platform to generate an eligible group. This eligible group may be a subset of accounts. The grouping criteria may include an associated mood qualifying as compatible with the mood indication, and accounts associated with client computing devices within a geographic distance of the first client computing device. The system may provide, to a second client computing device associated with the selected account, the first offer. The system may also receive, from the second client computing device, a first response to the first offer. The system may also receive, from the second client computing device, a first response to the first offer. Further, the system may provide, to the first client computing device, a notification indicating the first response.

### BRIEF DESCRIPTION OF THE DRAWINGS

Embodiments are illustrated by way of example, and not by way of limitation, in the figures of the accompanying drawings and in which like reference numerals refer to similar elements.

FIG. 1 shows a schematic diagram of a system, in accordance with one or more embodiments.

FIG. 2 shows an example depiction of a connection graph in accordance with one or more embodiments.

FIGS. 3A-3C show exemplary displays of a social networking platform operating on a client computing device.

FIGS. 4-17 show exemplary displays of a social networking platform operating on a client computing device.

FIG. 18 shows a flowchart of an exemplary process, in accordance with one or more embodiments.

FIGS. 19 and 20 show a computing system and network architecture in accordance with one or more embodiments.

### DETAILED DESCRIPTION

A portion of the disclosure of this patent document may contain material that is subject to copyright protection. The copyright owner has no objection to the facsimile reproduction by anyone of the patent document or the patent disclosure, as it may appear in the Patent and Trademark Office patent file or records, but otherwise reserves all copyrights whatsoever.

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It will be apparent to one of ordinary skill in the art that the invention can be practiced without these specific details. In other instances, well-known features have not been described in detail to avoid unnecessarily complicating the description.

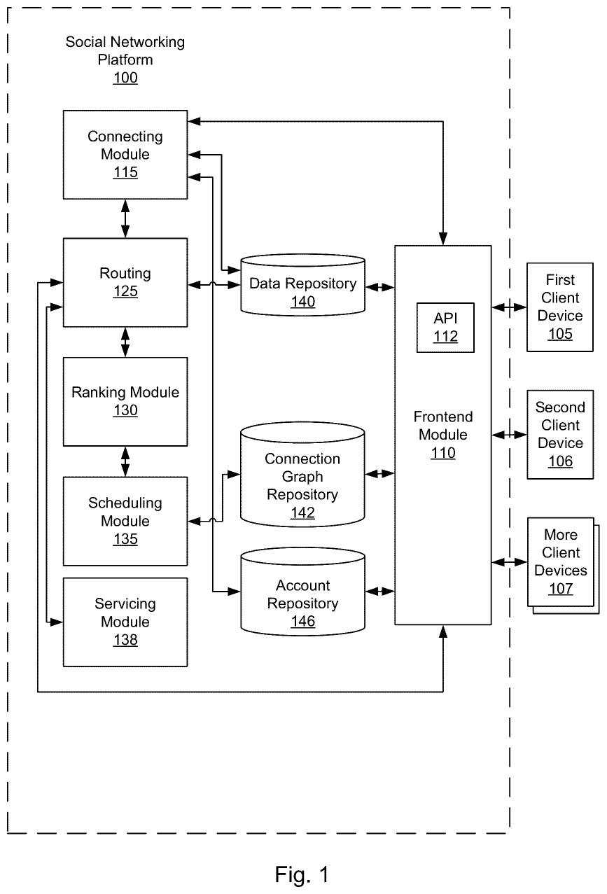

FIG. 1 shows a social networking platform 100 and client computing devices 105-107 in accordance with one or more embodiments. As shown in FIG. 1, the social networking platform 100 has multiple components including a frontend module 110 with an application programming interface (API) 112, a connecting module 115, a routing module 125, a ranking module 130, a scheduling module 135, a message repository 140, a connection graph repository 142, and an account repository 146. Client computing devices 105-107 may be communicatively coupled with the social networking platform 100.

Various components of the social networking platform 100 can be located on the same device (e.g., a server, mainframe, desktop Personal Computer (PC), laptop, Personal Digital Assistant (PDA), telephone, mobile phone, kiosk, cable box, and any other device) or can be located on separate devices connected by a network (e.g., a local area network (LAN), the Internet, etc.). Those skilled in the art will appreciate that there can be more than one of each separate component running on a device, as well as any combination of these components within a given embodiment. Further, while the components are depicted as being coupled with other components in a particular way, any permutation of couplings is possible.

In one or more embodiments, the social networking platform 100 is a platform for facilitating real-time communication between one or more entities. For example, the social networking platform 100 may store millions of accounts of individuals, businesses, and/or other entities (e.g., pseudonym accounts, novelty accounts, etc.). One or more users of each account may use the social networking platform 100 to send messages to other accounts inside and/or outside of the social networking platform 100. The social networking platform 100 may be configured to enable users to communicate in “real-time” (i.e., to converse with other users with a minimal delay and to conduct a conversation with one or more other users during concurrent sessions). In other words, the social networking platform 100 may allow a user to broadcast messages and may display the messages to one or more other users within a reasonable time frame so as to facilitate a live conversation between the users. Recipients of a message may have a predefined graph relationship with an account of the user broadcasting the message (e.g., based on an asymmetric graph representing accounts as nodes and edges between accounts as relationships). In one or more embodiments, the user is not an account holder or is not logged in to an account of the social networking platform 100. In this case, the social networking platform 100 may be configured to allow the user to broadcast messages and/or to utilize other functionality of the social networking platform 100 by associating the user with a temporary account or identifier.

In one or more embodiments, the connecting module 115 includes functionality to facilitate interactions of accounts of the social networking platform 100. Relationships between accounts of the social networking platform 100 can be represented by a connection graph.

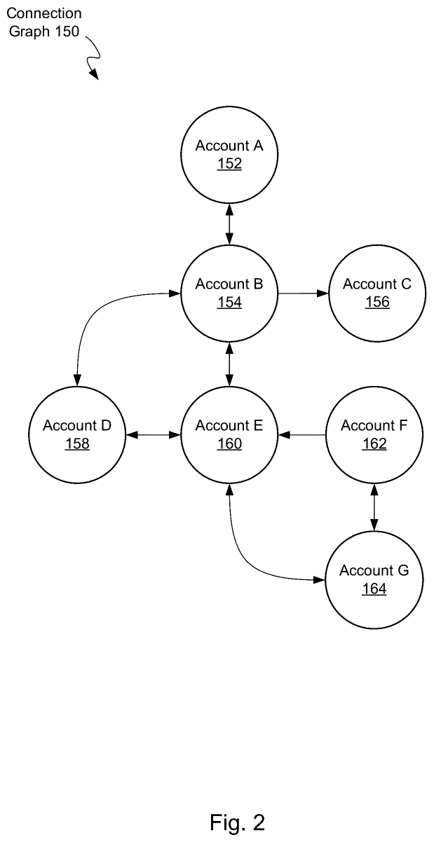

FIG. 2 shows an example depiction of a connection graph 150 in accordance with one or more embodiments. In one or more embodiments, the connection graph repository 142 is configured to store one or more connection graphs. As shown in FIG. 2, the connection graph 150 includes multiple components including nodes representing accounts of the social networking platform 100 (i.e., Account A 152, Account B 154, Account C 156, Account D 158, Account E 160, Account F 162, Account G 164) and edges connecting the various nodes.

The connection graph 150 is a data structure representing relationships (i.e., connections) between one or more accounts. The connection graph 150 represents accounts as nodes and relationships as edges connecting one or more nodes. A relationship may refer to any association between the accounts (e.g., following, friending, subscribing, tracking, liking, tagging, and/or etc.). The edges of the connection graph 150 may be directed and/or undirected based on the type of relationship (e.g., bidirectional, unidirectional), in accordance with various embodiments.

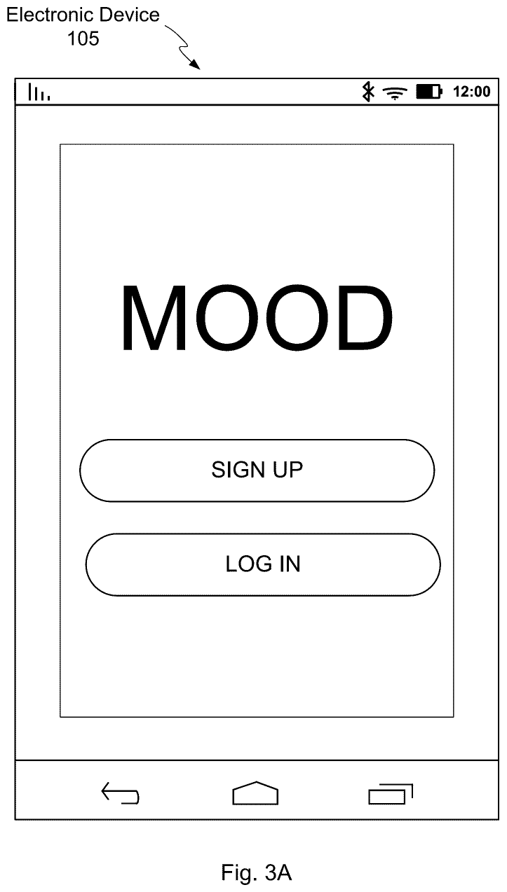

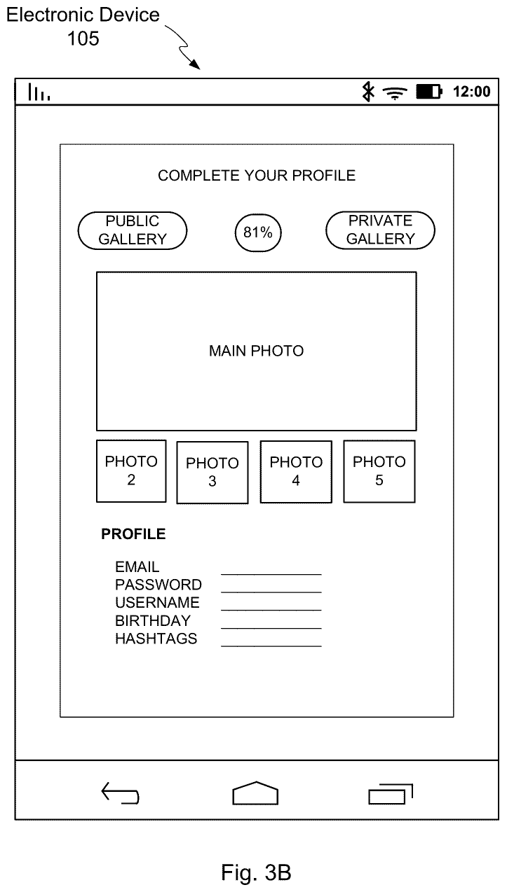

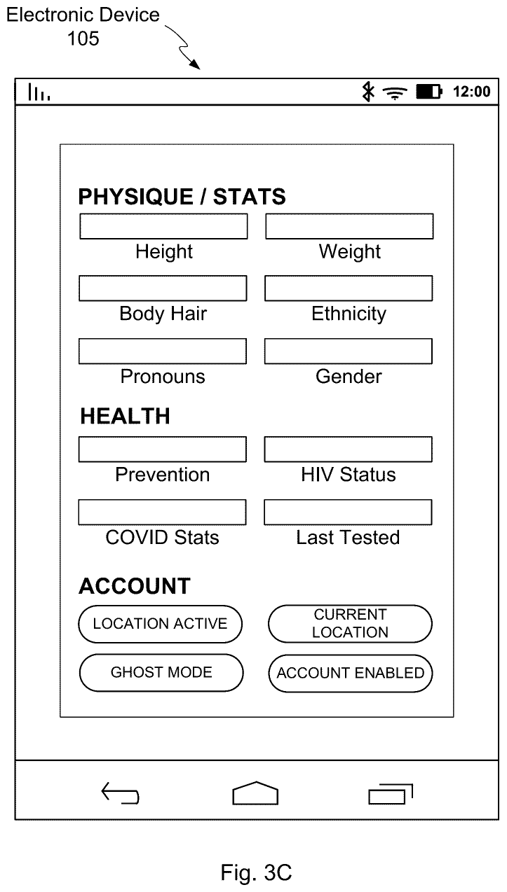

FIG. 3A shows an exemplary display of a social networking platform 100 operating on a client computing device 105 that can connect users. In various embodiments, a first user may access their account via their client computing device 105. Client computing device 105 may be associated with the user's account on the social networking platform 100 (e.g., the user may be logged into their account). A second user may access their account via their client computing device 106, and more users may access their accounts via their client computing devices 107.

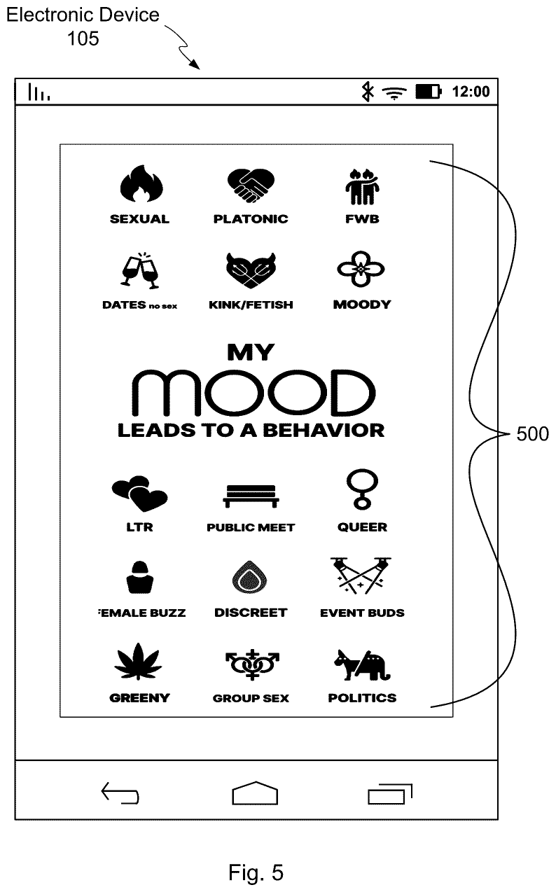

In one or more embodiments, the social networking platform 100 includes functionality to provide a set of moods to the first user account and receive an indication of a mood from the first user account. For example, a user may indicate their mood based on a set of moods 500 (FIG. 5) (e.g., by selecting one or more moods, or in other ways as discussed herein), and thereby send a mood indication to the social networking platform 100, which may be executing at least in part on one or more client computing devices 100, a cloud, a central server, etc.

It should be understood that while the mood indication or mood information used to determine a mood indication may originate from a user device associated with the first user account (e.g., client computing device 105), it may or may not be sent directly to the social networking platform 100 through a network. For example, the mood indication or information may be first provided to one or more intermediate entities (e.g., 3^{rd} party servers) which in turn ultimately provide the mood indication or information to the social networking platform 100. In one example, a client software application associated with the social networking platform 100 and executing on the user device may first provide the mood indication or information to an intermediate application executing on the user device which in turn provides the mood indication or information to an intermediate cloud service which in turn ultimately provides the mood indication or information to the social networking platform 100, or to the social networking platform 100.

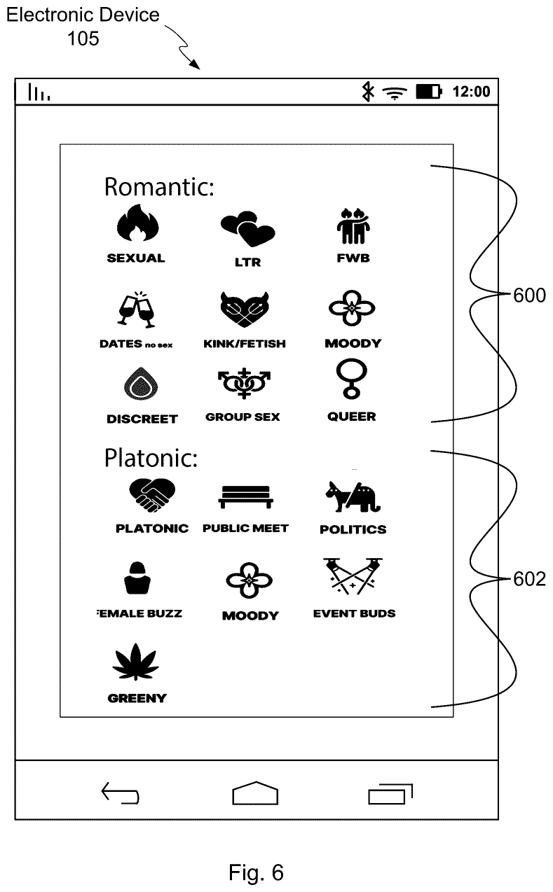

In some embodiments, moods are presented based on grouping by similarities or categories. For example, with reference to FIG. 6, moods 600 (which may be the same as, similar to, or a subset of moods 500) are grouped based on their romantic nature while moods 602 are grouped based on their platonic nature. In some embodiments, a first view may show only the categories (e.g., romantic and platonic), then upon selection of a category, a second view may show the moods corresponding to the selected category (e.g., showing moods 602 if platonic was selected). In some embodiments, only a subset of potential moods will be shown to a user (e.g., so that the user is not overwhelmed by too many potential moods at once, so that the menu/options of moods are customized, or any other reason).

In various embodiments described herein, the mood set 500 may include moods such as, but is not limited to, Sexual, Platonic, Friends With Benefits, Dates With No Sex, Kink/Fetish, Moody, Long Term Romance, Public Meet, Queer, Female Buzz, Discreet, Event Buds, Greeny (e.g., a mood related to cannabis/marijuana/CBD/etc.), Group Sex, or Politics.

In some embodiments, the mood indication may be selected based at least in part by data from a client computing device such as a mood ring, a smart watch, a sleep tracking device (e.g., ring, bracelet, headband, etc.), a smartphone, any other wearable client computing device that a user wears, or a client computing device that a user does not wear.

Further, in some embodiments, the indicated mood may be suggested and/or selected by a user's activities/calendar. For example, if social networking platform 100 accesses a user's calendar and the calendar shows that a user is going to a yoga class, then social network platform 100 may suggest or select the Greeny mood to pair yoga with another relaxing activity.

As another example, social networking platform 100 may predict which indicated mood a user will be in at a certain day and/or time. This may be based on typical behavior of the user or other users. For example, social networking platform 100 may suggest and/or select a dancing mood or dating mood on a Friday night, based on typical behavior of the user or other users. In another example, social networking platform 100 may receive explicit indications from the user defining the user's future mood. For example, the user may indicate that the mood for every Friday night should be set to dancing mood. Social networking platform 100 may also suggest a location and/or provide directions to a location based on a user's previous behaviors.

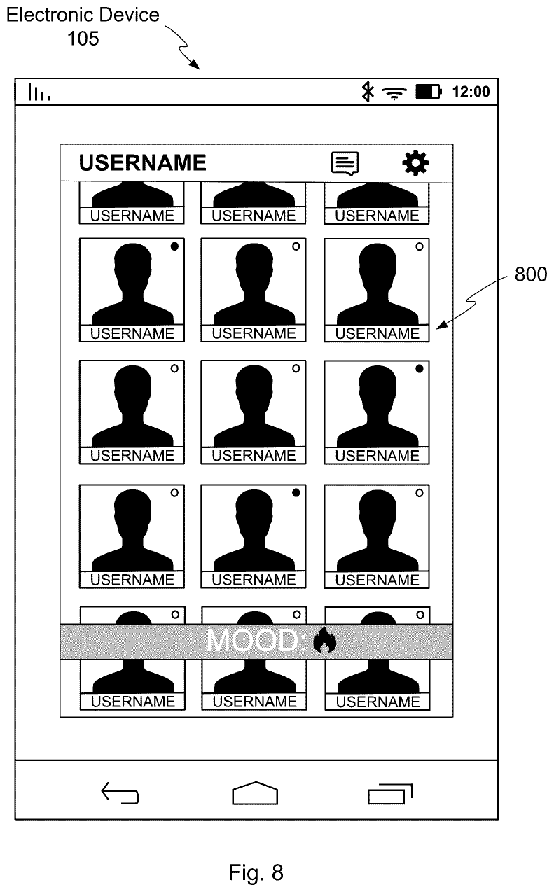

In one or more embodiments, the social networking platform 100 includes functionality to apply at least two sets of grouping criteria to a set of accounts of social networking platform 100 to generate an eligible group 800 (FIG. 8). Eligible group 800 may be a subset of the set of accounts of social networking platform 100. The social networking platform 100 may apply at least two sets of grouping, which may include, but are not limited to: (1) only accounts with a mood qualifying as compatible with the first user's mood indication, and (2) only accounts associated with client computing devices within a geographic distance of first client computing device 105. For example, the eligible group 800 may be other users that selected the same mood that the user selected (or, as discussed herein, a compatible mood).

Further, eligible group 800 may only include users that are located in a threshold distance of the user. Current, recent, past, and/or frequent locations of users may be determined based on location information corresponding to user devices, for example, client computing devices 105-107 associated with corresponding user accounts. Location information corresponding to user devices such as client computing devices 105-107 may be determined based on GPS, Wi-Fi Positioning, Bluetooth Positioning, and/or any other location tracking technologies.

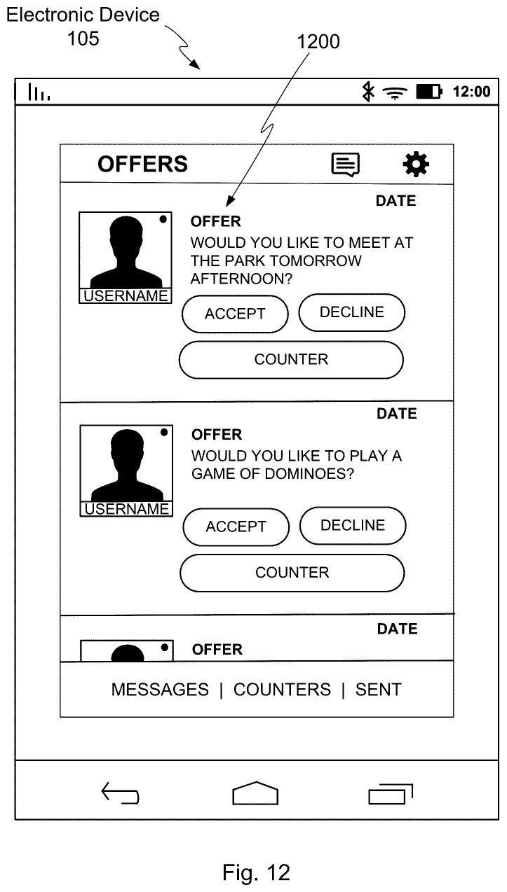

In one or more embodiments, the social networking platform 100 includes functionality to provide the eligible group 800 to the client computing device 105 for display, and may receive an identification of a selected account in eligible group 800. The social networking platform 100 may also receive an identification or definition of a first offer 1200 (FIG. 12), or the social networking platform 100 may provide a set of offer choices to the client computing device 105 and receive an identification of a first offer 1200 from the offer choices. For example, a user may select another user from eligible group 800 and send them offer 1200. Offer 1200 may include a message, such as “would you like to meet up at 8 p.m. at my house?”, “Would you like to meet at your apartment tomorrow?”, “Would you like to meet at the national mall at 9 a.m. sometime this week?”, or “Would you like to video chat?”. As discussed herein, offers may be predefined or custom. For example, predefined offers may include an activity/game, and/or a question such as, “Would you like to chat?”, or “How is your day going?”. In some embodiments, predefined offers may be suggested to a user based on offers sent by other users of social networking platform 100. For example, a predefined message that is chosen by a certain number of other users may be suggested to a user by social networking platform 100. As another example, machine learning may be used by social networking platform 100 to determine one or more predefined offers to be suggested to a user.

In some embodiments, the mood indication may determine the “workflow” or subsequent steps made available to the user. For example, what types of predetermined offers and/or counteroffers are presented to a user, what type of subject matter can be sent to another user (e.g., a user may not be able to send sexual imagery to another user if the two users were connected because they both chose a platonic mood), an amount of time a user has to respond (to an offer, counteroffer, and/or message), what types of counteroffers may be sent, how many messages may be sent, etc.

In one or more embodiments, the social networking platform 100 includes functionality to receive multiple selections of users from the eligible group. For example, a user may select more than one user from eligible group 800. As described above, the selections may be better than other social networking platforms because the eligible group 800 may only include users that are in the same or a compatible mood with respect to the first user's mood indication.

In one or more embodiments, the social networking platform 100 includes functionality to provide offer 1200 to a second client computing device 106 being used by another user, and first client computing device 105 may receive a response to offer 1200. Further, a notification may be provided to the first client computing device 105 indicating the first response. For example, offer 1200 may be provided from the first client computing device to the second client computing device 106, and may request a video chat with the second user. The second user may respond by accepting offer 1200 and that response may be provided to the first client computing device. The first user may then be notified of the response, either within an application or via a notification on their smartphone, smart watch, etc.

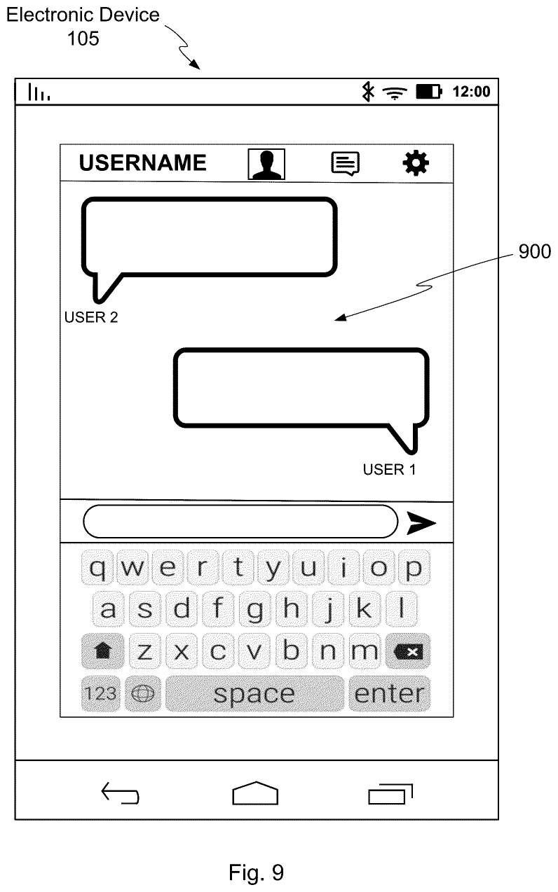

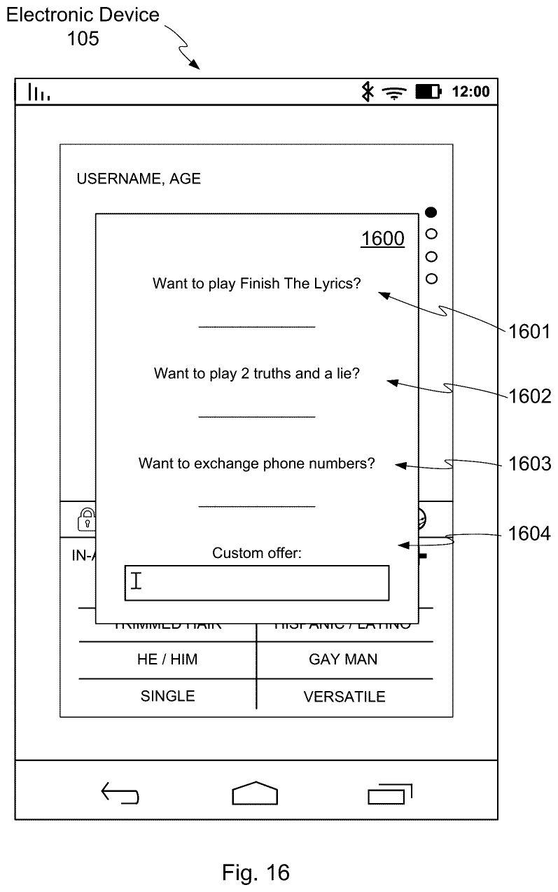

The response may accept offer 1200, and the two users may then be able to chat (e.g., via chat app 900 (FIG. 9)) included in social networking platform 100, exchange phone numbers, begin a video call, etc. As discussed herein, social networking platform 100 may provide a set of predefined/suggested offers 1600 (offers 1601-1603 in FIG. 16) and/or responses, which may be based on one or more moods 500 selected by the users. FIG. 16 also includes an option to define a custom offer.

As described above, a mood indication may include one mood 500, and that mood (e.g., that other users may also have selected) may qualify as compatible with the mood indication because it includes only the one mood 500. For example, a user may select a single mood 500, and users qualifying as compatible and/or shown in eligible group 800 may have chosen the same exact mood as the user. Alternatively, in some embodiments, compatible moods need not be the same exact mood, but instead simply related moods. For example, in some embodiments, Public Meet and Event Buds may be compatible moods (e.g., because of their shared platonic and often outdoor nature). In another example, in some embodiments, No Sex Dates and Long-Term-Relationship may be compatible moods (e.g., because of their often shared initial platonic nature).

In some embodiments a first user may choose more than one mood and/or a second user may choose one or more moods, and the second user may be included in eligible group 800 because one of the moods they chose is the same as the one mood of the moods selected by the first user (e.g., like an “or” operation where any of the first, second, etc. mood selected by the first user being the same as a mood selected by the second user is sufficient). Or, the second user may be included in eligible group 800 because one of the moods they chose is the same as at least one of the mood selected by the first user (in other words, only one same mood is enough, like an “or” operation). Or, the second user may be included in eligible group 800 because the multiple moods they chose are the same as the multiple moods selected by the first user (in other words, the same combination of moods were required, like an “and” operation).

For example, a first user may only select the mood Friends With Benefits and only be shown other users that only selected with Friends With Benefits. Or, a first user may select the mood Queer and be shown users that selected both Friends With Benefits and Queer. As another example, a first user may select a group of moods including the mood Fetish, and a second user may select a different group of moods that also include the mood Fetish. In that case, the first user may be shown the second user even though their groups of selected moods are not identical. In some embodiments, these types (or a portion of them) may require a paid membership to access.

In various embodiments, moods qualifying as compatible with the mood indication include the mood corresponding to the mood indication and at least one other mood 500. For example, the user may select mood 500 and the moods qualifying as compatible with selected mood 500 may be the selected mood 500 and at least another mood. In such an example, a user may select the mood Kink, and they may be shown users that have selected not only Kink, but also Group Sex, Friends With Benefits, and/or other moods 500.

In various embodiments, the mood indication includes a first mood 500 and a second mood 500, and applying the at least two sets of grouping criteria further comprises only accounts with associated moods 500 qualifying as compatible with both the first mood 500 and the second mood 500. For example, a first user might select two moods, and then be shown other users the have selected moods that are compatible with both of the moods selected by the first user. In some embodiments, a user may select Group Sex and Kink, and then only be shown users that have selected both Group Sex and Kink also.

In various embodiments, a set of offer choices 1600(1)-(3) may be offered to client computing device 105, wherein the set of offer choices 1600(1)-(3) are based on at least the mood indication, and wherein the first offer 1600(1) indicates at least one offer from the set of offer choices 1600(1)-(3). For example, a user may be provided with a set of offers 1600(1)-(3) to choose when they decide to send an offer 1200 to a member of eligible group 800. The set of offer choices 1600(1)-(3) may be based on the mood 500. The first offer (e.g., the one that is sent to another user) 1600(1) may be one of the set of offers 1600(1)-(3). As an example, a user may select another user where both users were found to be compatible based on their selection of the Greeny mood. Social media platform 100 may then suggest offers such as “Would you like to meet at the public park at 4:20 p.m.?” or “Would you like to smoke and play some video games online?”.

In various embodiments, offer 1200 indicates at least one custom offer received from first client computing device 105. For example, a user may send a custom offer (e.g., one that is not created by social media platform 100). A user's custom offer may include a user-created message, uploaded multimedia, etc.

In various embodiments, a response may include an acceptance of offer 1200, and in response to receiving the response, the first account and the second account communicate at a promoted level. For example, a first user may send offer 1200 that is accepted by a second user. The second user and the first user may then have new abilities at a promoted level, such as the ability to freely send messages to each other or video chat.

In various embodiments, a response includes a declination of offer 1200, and in response to receiving the declination, the first account and second account are prevented from continuing further interaction for a period of time. For example, after a first user sends offer 1200 to a second user, and the second user rejects offer 1200, then the first user and the second user may be prevented from communicating (e.g., sending offers to each other) for at least 24 hours.

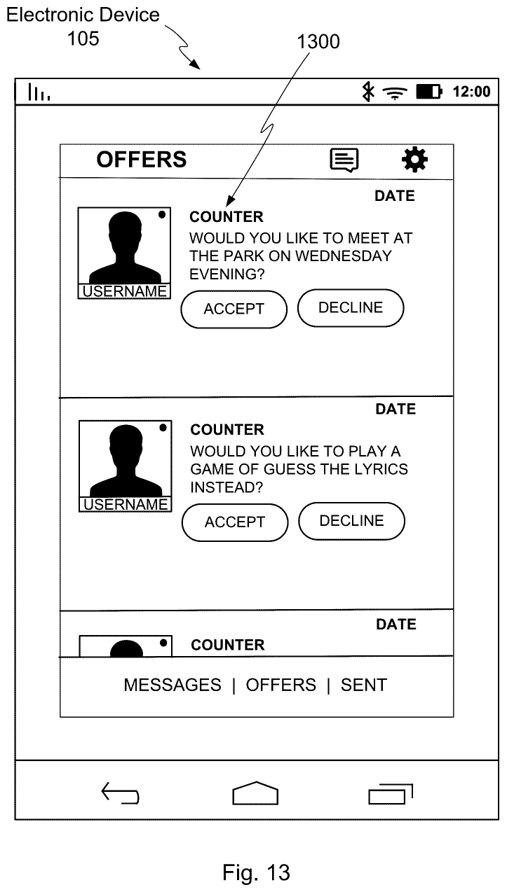

In various embodiments, a response to offer 1200 may include a counteroffer 1300 (FIG. 13). An acceptance to counteroffer 1300 may be made at first client computing device 105, and in response to that acceptance, the first account may be allowed to communicate with the second account at a promoted level. For example, a first user may send offer 1200 to a second user, and the second user may—rather than accept or deny the offer—send counteroffer 1300 to the first user. If the first user accepts counteroffer 1300, then the two users may go to a promoted level, where they may have new abilities such as the ability to freely send messages to each other or video chat. It should be understood that, similar to other offers discussed herein, counteroffers may be a custom offer (e.g., a message drafted by a user), and/or a predefined offer (e.g., a predefined/suggested message).

In various embodiments, a response to offer 1200 may include counteroffer 1300 to offer 1200, and the first client computing device then may decline counteroffer 1300, and in response to that declination, the first account and the second account may be prevented from continuing further interaction for a period of time. For example, if a first user sends offer 1200 to a second user, and that second user sends counteroffer 1300 to that first user, and then that first user rejects counteroffer 1300, then the first user and second user may be prevented from communicating (e.g., they may be prevented from sending offers to each other) for a threshold period of time, such as a day or a week.

In various embodiments, offer 1200 may be a game that the first account can play with the second account. For example, offer 1200 sent from a first user may include an invitation to play dominoes.

FIG. 3B shows an exemplary display of a social networking platform 100 operating on client computing device 105. FIG. 3B shows a portion of social networking platform 100 where a user may be able to enter information about themselves, such as one or more photos of themselves, and other information such as their birthday or user names. As shown in FIG. 3B, social networking platform 100 may allow a user to create a public version of their profile and a private version of their profile. For example, a public profile may only include a subset of a user's pictures or personal information.

FIG. 3C shows an exemplary display of social networking platform 100 operating on a client computing device 105. Similar to FIG. 3B, FIG. 3C illustrates an example form for a user to enter information about themselves. They may enter information about their physique or health. FIG. 3C also illustrates a setting a user may use such as whether social networking platform 100 has access to their location or whether a user's account is currently enabled.

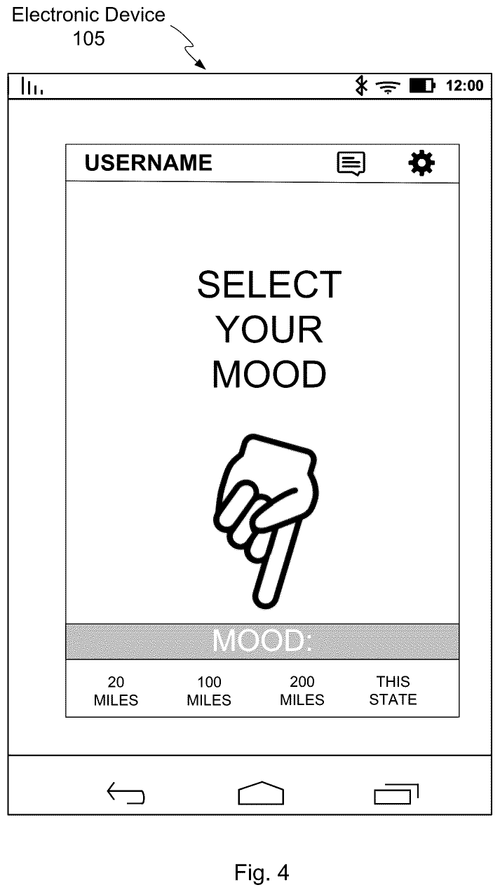

FIG. 4 shows an exemplary display of social networking platform 100 operating on a client computing device 105. In some embodiments, social networking platform 100 may allow a user to select their mood, and/or select how far away potential compatible users may be (e.g., 20 miles from the user, 100 miles from the user, or within the user's state).

FIG. 5 shows an exemplary display of social networking platform 100 operating on a client computing device 105. FIG. 5 illustrates various moods 500 that a user may choose from. The moods shown in FIG. 5 are not meant to be exhaustive, but merely illustrative of types of moods a user may select.

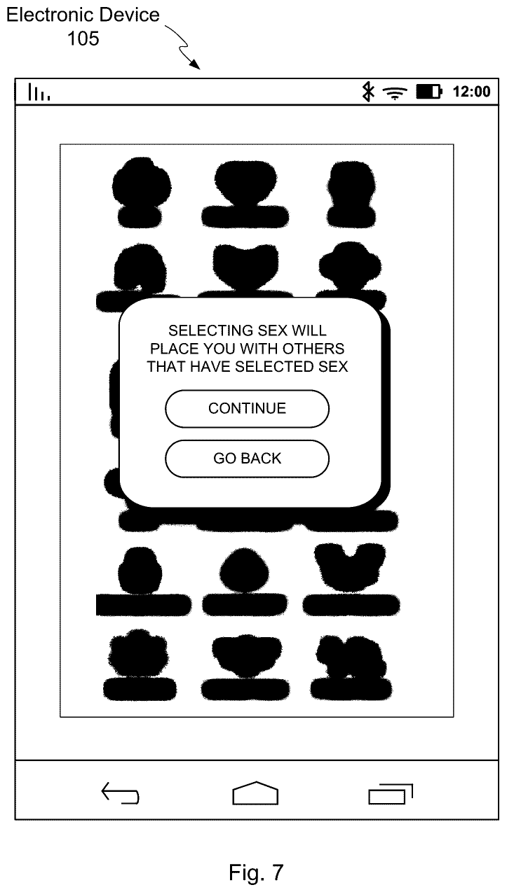

FIG. 7 shows an exemplary display of social networking platform 100 operating on a client computing device 105. FIG. 7 illustrates an example prompt that a user must complete before they are able to view an eligible group 800. For example, if a user selects a mood such as Friends With Benefits or Greeny, the user may be asked if they understand that members of eligible group 800 also selected that mood. In some embodiments, the prompt may be a warning (e.g., that indicates NSFW profile images may be shown if a user continues).

FIG. 8 shows an exemplary display of social networking platform 100 operating on a client computing device 105. FIG. 8 illustrates an example eligible group 800. In some embodiments, social networking platform 100 may show a user photos, names, locations, whether a user is online, which moods 500 a user chose, and other characteristics of users in eligible group 800.

Eligible group 800 may include users that entered the same mood as a first user. In some embodiments, eligible group 800 may be prevented from showing users that selected a particular mood 500. For example, in the social networking platform's settings a user may be able to select an option that prevents eligible group 800 from including users who chose moods 500 such as Friends With Benefits.

FIG. 8 shows an exemplary display of social networking platform 100 operating on a client computing device 105. In some embodiments, social networking platform 100 provides means to chat (e.g., via a chat app 700), which may include messages or a video chat. In some embodiments, users are not able to chat with each other unless a first user has sent offer 1200 (or counteroffer 1300) to a second user, and the second user has accepted offer 1200 (or counteroffer 1300).

In some embodiments, a first user may not be able to chat with a second user after a threshold amount of time. For example, after a first user accepts offer 1200 (or counteroffer 1300) from a second user they may be given the ability to chat. That ability to chat may be revoked after a certain amount of time such as 24 hours. In some embodiments, users may be given a prompt where they are able to choose whether to extend the amount of time.

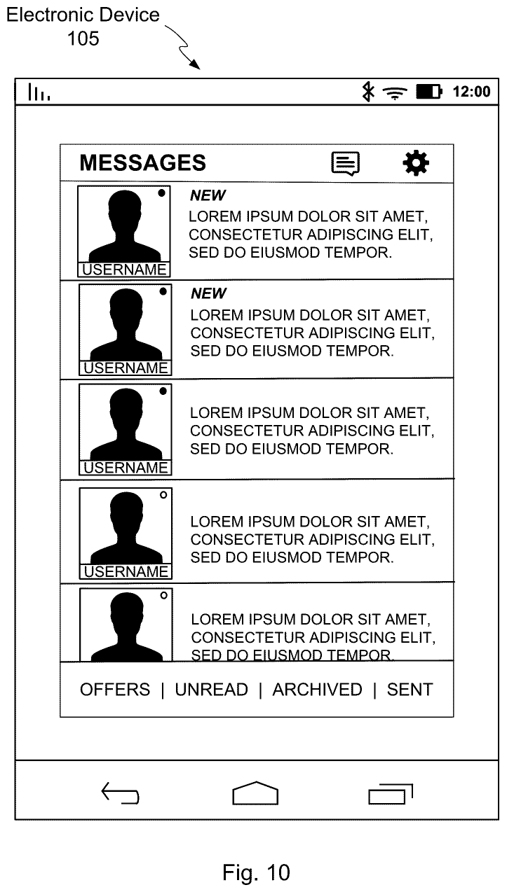

FIG. 10 shows an exemplary display of social networking platform 100 operating on a client computing device 105. Social networking platform 100 may include a screen that shows a user what messages they have received from other users. In various embodiments, social networking platform 100 may show which messages have been opened, which ones are new, and information about the user that sent a message such as whether that user is online. In some embodiments, a message may be/include offer 1200, an acceptance, a declination, or counteroffer 1300.

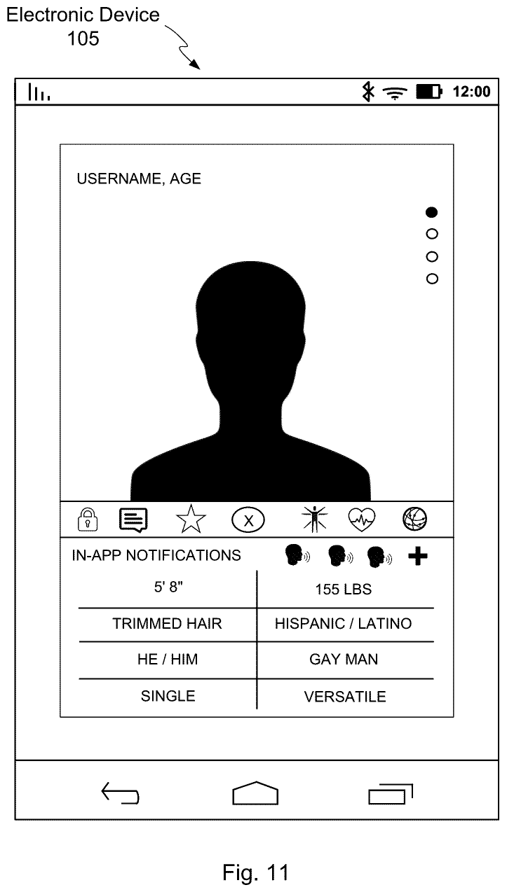

FIG. 11 shows an exemplary display of social networking platform 100 operating on a client computing device 105. FIG. 11 illustrates a user profile, in accordance with some embodiments. A user may select a user (e.g., from a screen that shows an eligible group 800, or from a screen that includes messages), and social networking platform 100 may provide a user profile that could include information about a user such as their ethnicity or height and weight. In some embodiments, a predefined/suggested offer may be based at least in part on information included in a user profile.

FIG. 12 shows an exemplary display of social networking platform 100 operating on a client computing device 105. FIG. 12 illustrates an exemplary screen that shows a user what offers 1200 they have received. In various embodiments, such a screen may allow a user to accept an offer, decline (e.g., decline) an offer, or submit counteroffer 1300. A user may filter offers they've sent by whether they have been accepted, declined, or unread.

FIG. 13 shows an exemplary display of social networking platform 100 operating on a client computing device 105. FIG. 13 illustrates an exemplary screen that shows a user what counteroffers 1300 they've received. In some examples, a user may not be able to respond to counteroffer 1300 with another counteroffer 1300, while in other embodiments a user may respond to counteroffer 1300 with another counteroffer 1300.

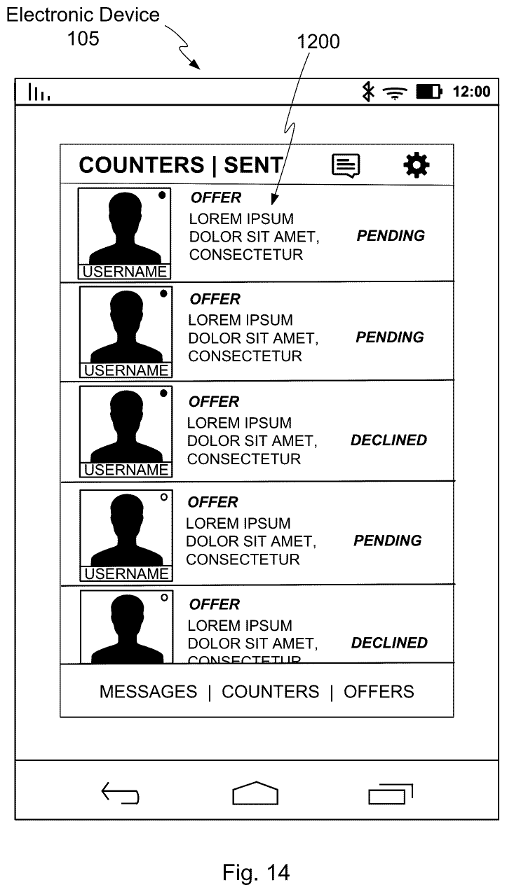

FIG. 14 shows an exemplary display of social networking platform 100 operating on a client computing device 105. FIG. 14 illustrates an exemplary screen that shows a user offers that they have sent. In various embodiments, such a screen may indicate whether an offer is pending, unread, declined, or accepted.

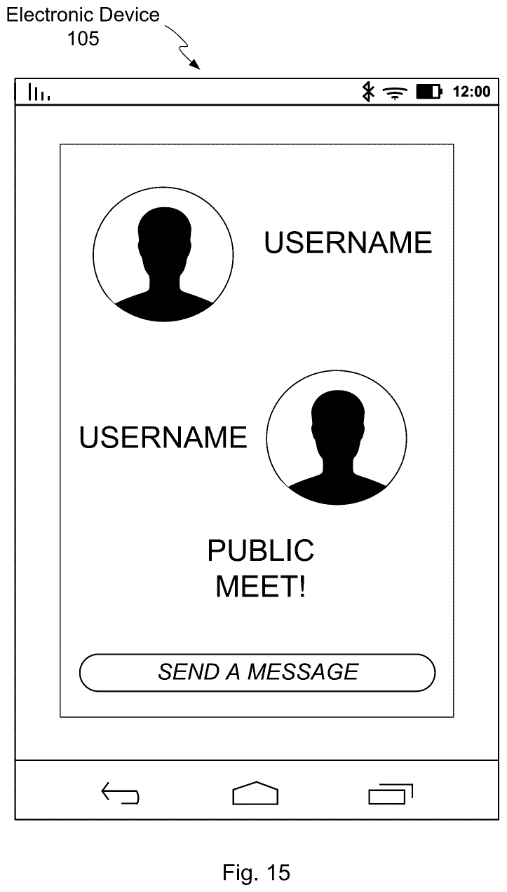

FIG. 15 shows an exemplary display of social networking platform 100 operating on a client computing device 105. FIG. 15 illustrates an exemplary screen that shows that a user accepted an offer. For example, in response to a user accepting offer 1200 or counteroffer 1300, social networking platform 100 may allow the users to send messages to each other.

FIG. 16 shows an exemplary display of social networking platform 100 operating on a client computing device 105. FIG. 16 illustrates an exemplary screen that allows a user to select an offer from a set of offers 1600(1)-(3). In FIG. 16, the example offers are games to send to another user as offer 1200. For example, in various embodiments, offer 1200 may be a game (or another interactive offer such as a survey or questions about another user). Such games may be suggested to a user based on attributes of another user or mood 500. Attributes may include whether a user has indicated that they enjoy games, or what type of games they enjoy. In some embodiments, a game may be one where a user guesses the lyrics of a song, or it may be a card game or action game.

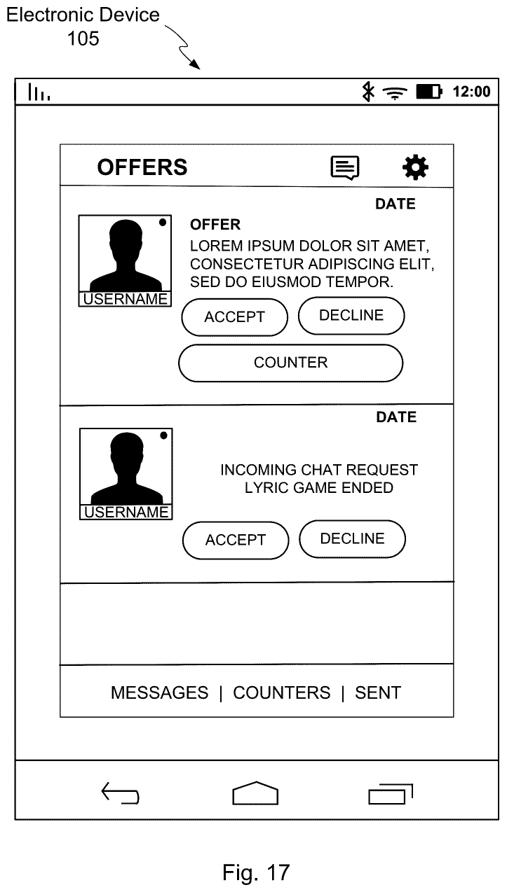

FIG. 17 shows an exemplary display of social networking platform 100 operating on a client computing device 105. FIG. 17 illustrates an exemplary screen that shows both offers 1200 that a first user has accepted, and a chat request from a second user that played a game with the first user. For example, a first user may send offer 1200 to a second user in the form of a game, and the users may not be able to chat until the game is complete. In some embodiments, after a game has been played, a first user may request to chat with a second user, and that second user may accept or decline the request.

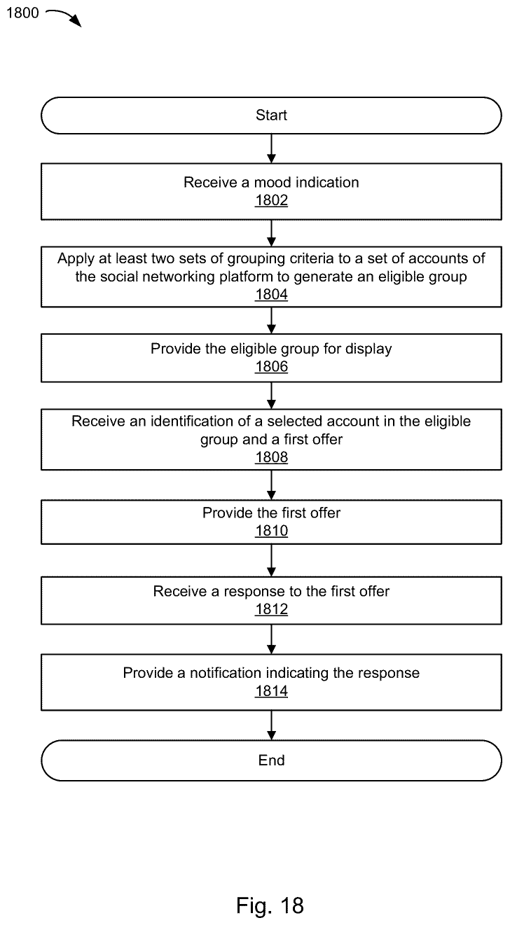

FIG. 18 shows a flowchart 1800 of a method performed on a social networking platform for connecting users. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 18 should not be construed as limiting the scope of the invention.

At STEP 1802, a mood indication is received. For example, a first user may select mood 1200 on their client computing device. A user may indicate that they are in the mood for Friends With Benefits, A Long Term Relationship, a Dancing Partner, or any number of other attributes.

At STEP 1804, at least two sets of grouping criteria are applied to a set of accounts on a social networking platform to generate eligible group 800. For example, social networking platform 100 may include thousands of user profiles, and the eligible group may be a subset of those user profiles. Grouping criteria such as whether mood 500 is qualified as compatible with a mood indication, or an account associated with a client computing device of a second user may be applied to eligible group 800. In such a case, users that selected the same mood as the first user, and whose client computing device is within 25 miles of the first user's client computing device, may be placed in eligible group 800. The location of a client computing device may be determined using a GPS transmitter or other wireless transmitter included in client computing device 105.

At STEP 1806, the eligible group is provided for display. For example, the first client computing device 105 may display the eligible group 800 that was created by applying grouping criteria to the user accounts.

At STEP 1808, an identification of a selected account in eligible group 800 and a first offer is received. For example, a first user may select an account that was included in the eligible group, and send an offer to that account. The offer may be a question, a message, an offer to meet at a certain place and time, and/or an interactive game or survey.

At STEP 1810 the first offer is provided. For example, the first offer sent from the first client computing device may be sent to the second device.

At STEP 1812, a response to the first offer is received. For example, the second user on their client computing device may respond to the first offer by selecting accept, decline, or provide counteroffer 1300. In some embodiments, counteroffer 1300 may include a question, a message, an offer to meet at a certain place and time, and/or an interactive game or survey.

At STEP 1814, a notification indicating the response is provided. For example, a first user may receive, at their client computing device, a response from the second user. This response may be an acceptance of offer 1200, a declination of offer 1200, or a counteroffer 1300. In some embodiments, a first user may respond to counteroffer 1300 with another counteroffer 1300. In some embodiments, if the second user declines offer 1200 or a first user declines counteroffer 1300, the two users will not be able to communicate (e.g., chat via messages, send each other offers) for a threshold amount of time.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

Embodiments may be implemented on a specialized computer system. The specialized computing system can include one or more modified mobile devices (e.g., laptop computer, smartphone, personal digital assistant, tablet computer, or other mobile device), desktop computers, servers, blades in a server chassis, or any other type of computing device(s) that include at least the minimum processing power, memory, and input and output device(s) to perform one or more embodiments.

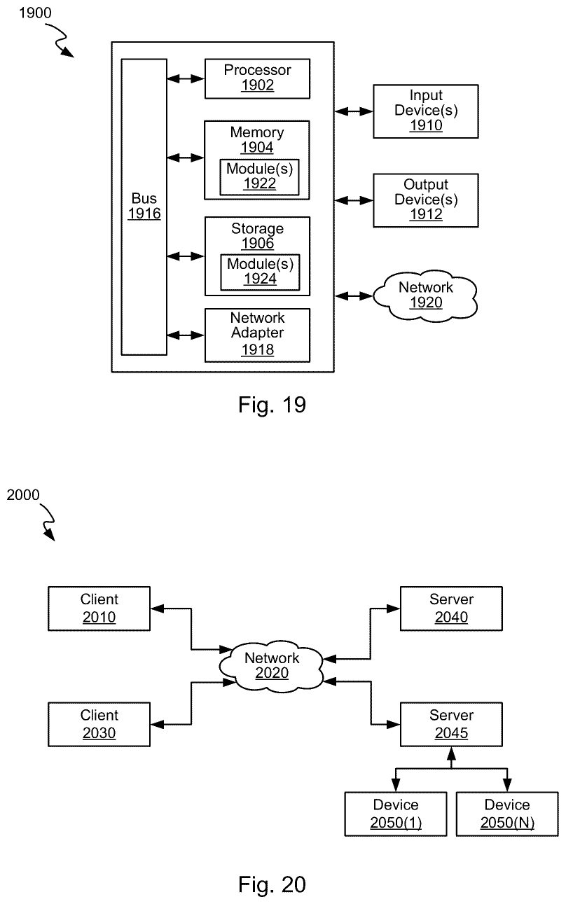

For example, as shown in FIG. 19, the computing system 1900 may include one or more computer processor(s) 1902, associated memory 1904 (e.g., random access memory (RAM), cache memory, flash memory, etc.), one or more storage device(s) 1906 (e.g., a hard disk, an optical drive such as a compact disk (CD) drive or digital versatile disk (DVD) drive, a flash memory stick, etc.), a bus 1916, and numerous other elements and functionalities. The computer processor(s) 1902 may be an integrated circuit for processing instructions. For example, the computer processor(s) may be one or more cores or micro-cores of a processor.

In one or more embodiments, the computer processor(s) 1902 may be an integrated circuit for processing instructions. For example, the computer processor(s) 1902 may be one or more cores or micro-cores of a processor. The computer processor(s) 1902 can implement/execute software modules stored by computing system 1900, such as module(s) 1922 stored in memory 1904 or module(s) 1924 stored in storage 1906. For example, one or more of the modules described herein can be stored in memory 1904 or storage 1906, where they can be accessed and processed by the computer processor 1902. In one or more embodiments, the computer processor(s) 1902 can be a special-purpose processor where software instructions are incorporated into the actual processor design.

The computing system 1900 may also include one or more input device(s) 1910, such as a touchscreen, keyboard, mouse, microphone, touchpad, electronic pen, or any other type of input device. Further, the computing system 1900 may include one or more output device(s) 1912, such as a screen (e.g., a liquid crystal display (LCD), a plasma display, touchscreen, or other display device), a printer, external storage, or any other output device. The computing system 1900 may be connected to a network 1920 (e.g., a local area network (LAN), a wide area network (WAN) such as the Internet, mobile network, or any other type of network) via a network interface connection 1918. The input and output device(s) may be locally or remotely connected (e.g., via the network 1920) to the computer processor(s) 1902, memory 1904, and storage device(s) 1906.

One or more elements of the aforementioned computing system 1900 may be located at a remote location and connected to the other elements over a network 1920. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

FIG. 20 is a block diagram of an example of a network architecture 2000 in which client systems 2010 and 2030, and servers 2040 and 2045, may be coupled to a network 2020. Network 2020 may be the same as or similar to network 1920. Client systems 2010 and 2030 generally represent any type or form of computing device or system, such as client devices (e.g., portable computers, smartphones, tablets, smart TVs, etc.).

Similarly, servers 2040 and 2045 generally represent computing devices or systems, such as application servers or database servers, configured to provide various database services and/or run certain software applications. Network 2020 generally represents any telecommunication or computer network including, for example, an intranet, a wide area network (WAN), a local area network (LAN), a personal area network (PAN), or the Internet.

With reference to computing system 1900 of FIG. 19, a communication interface, such as network adapter 1918, may be used to provide connectivity between each client system 2010 and 2030, and network 2020. Client systems 2010 and 2030 may be able to access information on server 2040 or 2045 using, for example, a Web browser, thin client application, or other client software. Such software may allow client systems 2010 and 2030 to access data hosted by server 2040, server 2045, or storage devices 2050(1)-(N). Although FIG. 20 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 2040, server 2045, storage devices 2050(1)-(N), or any combination thereof. All or a portion of one or more of the example embodiments disclosed herein may also be encoded as a computer program, stored in server 2040, run by server 2045, and distributed to client systems 2010 and 2030 over network 2020.

Although components of one or more systems disclosed herein may be depicted as being directly communicatively coupled to one another, this is not necessarily the case. For example, one or more of the components may be communicatively coupled via a distributed computing system, a cloud computing system, or a networked computer system communicating via the Internet.

And although only one computer system may be depicted herein, it should be appreciated that this one computer system may represent many computer systems, arranged in a central or distributed fashion. For example, such computer systems may be organized as a central cloud and/or may be distributed geographically or logically to edges of a system such as a content/data delivery network or other arrangement. It is understood that virtually any number of intermediary networking devices, such as switches, routers, servers, etc., may be used to facilitate communication.

While the invention has been described with respect to a limited number of embodiments, those skilled in the art, having benefit of this disclosure, will appreciate that other embodiments may be devised that do not depart from the scope of the invention as disclosed herein.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

What is claimed is:

1. A method performed on a social networking platform, comprising:
receiving, from a first client computing device associated with a first account, a mood indication;
applying, by a computer processor, at least two sets of grouping criteria to a set of accounts of the social networking platform to generate an eligible group, wherein:
the eligible group is a subset of the set of accounts, and
applying the at least two sets of grouping criteria comprises:
including only accounts with an associated mood qualifying as compatible with the mood indication, and
including only accounts associated with client computing devices within a geographic distance of the first client computing device;
providing, to the first client computing device, the eligible group for display;
receiving, from the first client computing device, an identification of a selected account in the eligible group and a first offer;
providing, to a second client computing device associated with the selected account, the first offer;
receiving, from the second client computing device, a first response to the first offer; and
providing, to the first client computing device, a notification indicating the first response.

2. The method of claim 1, wherein the mood indication includes only one mood, and wherein a mood qualifying as compatible with the mood indication includes only the one mood corresponding to the mood indication.

3. The method of claim 1, wherein moods qualifying as compatible with the mood indication include the mood corresponding to the mood indication and at least one other mood.

4. The method of claim 1, wherein:
the mood indication includes a first mood and a second mood; and
the applying the at least two sets of grouping criteria further comprises including only accounts with associated moods qualifying as compatible with both the first mood and the second mood.

5. The method of claim 1:
further comprising providing a set of offer choices to the first client computing device, wherein the set of offer choices are based on at least the first mood indication; and
wherein the first offer indicates at least one offer from the set of offer choices.

6. The method of claim 1, wherein the first offer indicates at least one custom offer received from the first client computing device.

7. The method of claim 1:
wherein the first response includes an acceptance to the first offer; and
further comprising, in response to receiving the first response, allowing the first account and the second account to communicate at a promoted level.

8. The method of claim 1:
wherein the first response includes a declination to the first offer; and
further comprising, in response to receiving the declination, preventing the first account and the second account to continue further interaction for a period of time.

9. The method of claim 1:
wherein the first response includes a counteroffer to the first offer; and
further comprising:
receiving, from the first client computing device, an acceptance to the counteroffer, and
in response to receiving the acceptance, allowing the first account and the second account to communicate at a promoted level.

10. The method of claim 1:
wherein the first response includes a counteroffer to the first offer; and
further comprising:
receiving, from the first client computing device, a declination to the counteroffer, and
in response to receiving the declination, preventing the first account and the second account to continue further interaction for a period of time.

11. The method of claim 1, wherein the offer is a game that the first account can play with the second account.

12. A system for a social networking platform, comprising:
a computer processor;
a memory; and
a connecting engine executing on the computer processor and configured to:
receive, from a first client computing device associated with a first account, a mood indication;
apply, by the computer processor, at least two sets of grouping criteria to a set of accounts of the social networking platform to generate an eligible group, wherein:
the eligible group is a subset of accounts, and
the application by the computer processor of the at least two sets of grouping criteria to generate the eligible group, wherein the grouping criteria include:
an associated mood qualifying as compatible with the mood indication, and
accounts associated with client computing devices within a geographic distance of the first client computing device;
provide, to a second client computing device associated with the selected account, the first offer;
receive, from the second client computing device, a first response to the first offer;
receive, from the second client computing device, a first response to the first offer; and
provide, to the first client computing device, a notification indicating the first response.

13. The system of claim 12, wherein the mood indication includes only one mood, and wherein a mood qualifying as compatible with the mood indication includes only the one mood corresponding to the mood indication.

14. The system of claim 12, wherein moods qualifying as compatible with the mood indication include the mood corresponding to the mood indication and at least one other mood.

15. The system of claim 12, wherein:
the mood indication includes a first mood and a second mood; and
the grouping criteria further comprises only accounts with associated moods qualifying as compatible with both the first mood and the second mood.

16. The system of claim 12, wherein:
the connecting engine executing on the computer processor is further configured to provide a set of offer choices to the first client computing device, wherein the set of offer choices are based on at least the first mood indication; and
the first offer indicates at least one offer from the set of offer choices.

17. The system of claim 12, wherein:
the first response includes an acceptance to the first offer; and
the connecting engine executing on the computer processor is further configured to allow, in response to receiving the first response, the first account and the second account to communicate at a promoted level.

18. The system of claim 12, wherein:
the first response includes a declination to the first offer; and
the connecting engine executing on the computer processor is further configured to prevent, in response to receiving the declination, the first account and the second account to continue further interaction for a period of time.

19. The system of claim 12, wherein:
the first response includes a counteroffer to the first offer; and
the connecting engine executing on the computer processor is further configured to:
receive, from the first client computing device, an acceptance to a counteroffer, and
in response to receiving the acceptance, allow the first account and the second account to communicate at a promoted level.

20. The system of claim 12, wherein:
the first response includes a counteroffer to the first offer; and
the connecting engine executing on the computer processor is further configured to:
receive, from the first client computing device, a declination to the counteroffer, and
in response to receiving the declination, prevent the first account and the second account to continue further interaction for a period of time.
